(19) United States
(12) Patent Application Publication
(10) Pub. No.: US 2010/0199293 A1
(43) Pub. Date: Aug. 5, 2010

(54) Inclinable pick-and-place head of disc pick-and-place device

(76) Inventor: Hung-Jui Lin, Taipei City (TW)

Correspondence Address: G LINK CO.,LTD, 3550 Bell Road, Minooka, IL, 60447, US

(21) Appl. No.: 12/007,148

(22) Filed: Jan. 7, 2008

(51) Int. Cl. G11B 7/00

(52) U.S. Cl. 720/672; G9B/7

(57) ABSTRACT

An inclinable pick-and-place head of a disc pick-and-place device comprises a first frame and a second frame movably coupled thereto; said first frame is coupled to a disc pick-and-place head; a first actuating mechanism may drive a bottom of the first frame to be near to or leave the second frame to cause a pick-and-place face of the pick-and-place head coupled to a disc is inclined to shorten a level width of the disc relative to an accepting groove of a disc tray. Thereby, an action similar to picking up and placing in a disc directly by a human's hand can be executed so that the disc is not blocked by tabs around the accepting groove or a panel of a copier to place in the accepting groove or take out from the accepting groove.

### BACKGROUND OF THE INVENTION

1. Field of the Invention

The present invention relates to a disc pick-and-place device of an automatic disc copier, and more particularly to an inclinable pick-and-place head of the disc pick-and-place device.

2. Description of Related Art

The price of a disc is cheap and convenient for storing a great amount of data such that it is still an important information storing media. There are many automatic disc coping technologies, for example, an automatic disc burning method and apparatus disclosed in Taiwan Patent No. 594693, an automatic disc feeding and disc picking-up system for a disc burner disclosed in Taiwan Patent Publishing No. 200515395 and an automatic multiple discs backup apparatus for a personal computer disclosed in Taiwan Patent No. 1228246. The Taiwan patents mentioned above all disclose a pick-and-place arm and a driving component used for driving the pick-and-place arm to rise and fall vertically and move transversely; the pick-and-place arm is used to automatically pick up a disc from or place a disc in a disc tray of a disc recording device or a disc tray of a disc cassette so as to attain to the automatic disc coping function.

The pick-and-place arm mentioned above comprises a disc pick-and place head. When a detection unit detects the disc pick-and-place head touching a disk in a disc tray of a copier, the disc pick-and-place head then carries out the disc picking and placing action. A side wall of a circumference of a disc mounting accepting groove of the disc tray is usually provided with a plurality of tabs projected out toward the accepting groove to allow the disc to be restricted below the plurality of tabs. Even more, one end of a certain accepting groove close to a panel of the copier is slightly contracted inside the panel. If the disc is caused to move downward vertically from a upper side of the accepting groove, the disc will be blocked by the tabs or the panel and unable to be placed in the accepting groove smoothly and accurately. Moreover, if the disc is caused to mover downward or upward vertically from an inside of the accepting groove, the disc will be blocked by the tabs or the panel and unable to be taken out smoothly.

For solving inconvenience caused from the manner of placing the disc in the accepting groove mentioned above, an action of picking up and placing in a disk directly by a human's hand is simulated to cause the disc to be inclined an angle to shorten a level width thereof, the disc can then be placed into the accepting groove. Vice versa, if the above-mentioned action is reversed, the disc can then be picked up smoothly from the accepting groove. Structures between the current disc pick-and-place head and pick-and-place arm all are a clamping type and lack of inclinable design; it is very difficult to place the disc into the accepting groove with the plurality of tabs or the accepting groove with one end thereof slightly contracted to the inside of the panel of the copier mentioned above.

### SUMMARY OF THE INVENTION

For allowing a disc pick-and-place head of a disc pick-and-place device to have the inclinable function, the present invention is provided.

The main object of the present invention is to provide an inclinable pick-and-place head of a disc pick-and-place device, capable of smoothly placing a disc in a disc tray of a copier or picking up a disc from the disc tray.

Another object of the present invention is to provide an inclinable pick-and-place head of a disc pick-and-place device, capable of more dependably placing a disc in a disc tray of a copier or picking up a disc from the disc tray so as to prevent the disc coping speed from being decreased because the incapability of the picking-up or the placing-in of the disc does not happen.

For attaining to the objects mentioned above, the present invention proposes an inclinable pick-and-place head of a disc pick-and-place device, used for allowing the pick-and-place head of the disc pick-and-place device to have the inclinable function and comprising:
a first frame, provided with at least one first supporting component;
a pick-and-place head, coupled to said first frame and used for picking up and placing in said disc;
a second frame, provided with at least one second supporting component; said first supporting component movably coupled to said second supporting component; and
a first actuating mechanism, used for actuating said first frame to cause a clamping face of said pick-and-place head coupled to said disc to be inclined to enable said disc to be smoothly placed in a tray or picked up from said tray, and said disc to be more dependably placed in said tray or picked up from said disc tray so as to prevent the disc coping speed from being decreased because the incapability of the picking-up or the placing-in of the disc does not happen.

### BRIEF DESCRIPTION OF THE DRAWINGS

The present invention can be more fully understood by reference to the following description and accompanying drawings, in which:

FIG. 1 is a front schematic view, showing an inclinable pick-and-place head of a disc pick-and-place device of a preferred embodiment according to the present invention;

FIG. 2 is a schematic view, showing a pick-and-place head of a disc pick-and-place device of the preferred embodiment according to the present invention;

FIG. 3 is a side schematic view, showing an inclinable pick-and-place head of a disc pick-and-place device of the preferred embodiment according to the present invention;

FIG. 4 is front schematic view, showing an inclinable pick-and-place head of a disc pick-and-place device of the preferred embodiment according to the present invention when a disc is picked up or placed in by the pick-and-place head; and

FIGS. 5A to 5C are side schematic views, respectively showing steps of placing a disc in a disc tray by an inclinable pick-and-place head of a disc pick-and-place device of a preferred embodiment according to the present invention.

### DETAILED DESCRIPTION OF THE PREFERRED EMBODIMENTS

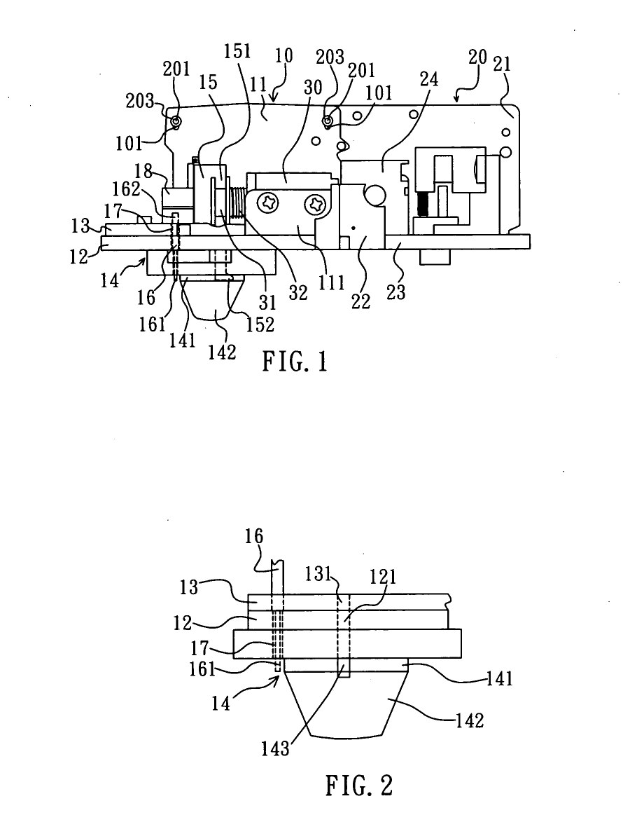

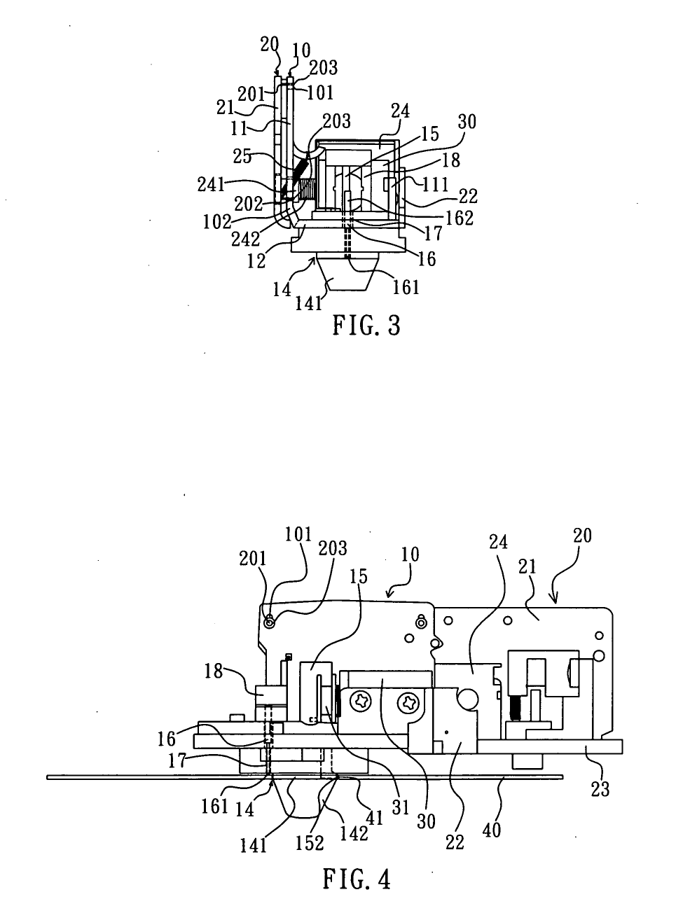

Please refer to FIGS. 1 and 3. According to a preferred embodiment of the present invention, an inclinable pick-and-place head of a disc pick-and-place device allows the pick-and-place head of the disc pick-and-place device to have the inclinable function; it comprises a first frame 10 and a second frame 20 movably coupled to the first frame 10, in which the first frame 10 comprises a first vertical plate 11, a second vertical plate 111 and a level plate 12, and the second frame 20 comprises a first vertical plate 21, a second vertical plate 22 and a level plate 23. A upper end of the first vertical frame 11 of the first frame 10 is provided with at least one first supporting component 101, for example, long slot.

An upper end of the first vertical plate 21 of the second frame 20 is coupled to at least one second supporting component 201, for example, pin. A lower end of the first vertical plate 11 of the first frame 10 is provided with at least one first guiding component 102, for example, long slot. A lower end of the first vertical plate 21 of the second frame 20 is coupled to at least one second guiding component 202. The first supporting component 101 is coupled to the second supporting component 201, and the first guiding component 102 is coupled to the second guiding component 202 to allow a lower end of the first frame 10 to be separated from or be near to a lower end of the second frame 20.

In the present embodiment, a C-ring 203 is respectively put around portions of the second supporting component 201 and the second guiding component 202 (pin) respectively passed through the first supporting component 101 and the first guiding component 102 (long slot). Two ends of a second elastic element 25 are respectively coupled to the vertical plates 11 and 21 of the first and the second frames 10 and 20, and the elastic element 25 always exerts a force to move the first frame 10 to be near to a lower end of the second frame 20. Besides, the second elastic element 25 may also be omitted and a gravity force is used to allow the first frame 10 to maintain a downward moving force.

The second vertical plate 22 of the second frame 20 is coupled to a first actuating mechanism 24, for example, first solenoid valve. The first actuating mechanism 24 is placed between the first and the second vertical plates 21 and 22 and above the level plate 23. A movable element 241 and an elastic element 242 are disposed on one end of the first actuating mechanism 24, in which the first elastic element 242 always exerts a force moving the first movable element 241 to be near to the first vertical plate 21 of the second frame 20; as the lower end of the first frame 10 is coupled to the first movable element 241, the first elastic element 242 always exerts a force moving the lower end of the first frame 10 to be near to the first vertical plate 21 of the second frame 20.

When the first actuating mechanism 24, for example, first solenoid valve, is acted, it can generate a force attracting the first movable element 241 to overcome an elastic force of the first elastic element 242 to leave the first vertical plate 21 of the second frame 20, and further to drive a lower end of the first vertical plate 11 of the first frame 10 to leave the first vertical plate 21 of the second frame 20.

As FIG. 2 shows, upper and lower sides of the level plate 12 are respectively coupled to a upper plate 13 and a pick-and-place head 14, in which the pick-and-place head 14 is provided with a neck portion 141, a cone-typed portion 142 and a first slot 143 respectively communicated with an outer part of a upper end of the pick-and-place head 14, the outsides of flank sides of the neck portion 141 and the cone-typed portion 142. Furthermore, the level plate 12 and the upper plate 13 are respectively provided with second and third slots 121,131 communicated with the first groove 143.

As FIGS. 1, 2 and 3 show, an actuating mechanism 30, for example, solenoid valve, is coupled to the second vertical plate 111, placed between the first and the second vertical plates 11 and 111 and above the level plate 12. A second movable element 31 and a third elastic element 32 are disposed on one end of the second actuating mechanism 30, in which the third elastic element 32 always exerts a force to move the second movable element 31 to leave the second actuating mechanism 30. When the second actuating mechanism 30, for example, solenoid valve, is acted, it can attract the second movable element 31 to move to be near to the second actuating mechanism 30.

A upper end 151 of a clamping portion 15 is coupled to the second movable element 31, and the clamping portion 15 can be driven to move levelly by the second movable element 31 and a lower end thereof is provided with a clamping element 152 accepted in the first slot 143. A probe rod 16 is accepted in a fourth slot 17 communicated with the upper plate 13, the level plate 12 and the pick-and-place head 14, in which a lower end 161 of the probe rod 16 is finer and a upper end 162 thereof is coarser, and they may respectively be extended out of the fourth slot 17, as FIG. 1 shows. A sensor 18, for example, optical interrupter, is placed in the scope of the operation of the upper end 162 of the probe rod 16 and may be actuated or not be actuated depending on the location change of the upper end 162.

Please refer to FIGS. 2 and 4. When The disc pick-and-place device of the present invention is driven to move toward a disc 40, the lower end 161 of the probe rod 16 will first touch the disc 40 and be moved upward to extract into the fourth slot 17 and a upper end of the probe rod 16 is followed to move upward to start the sensor 18 to cause the sensor to generate a first signal and allow the second actuating mechanism 30 to be started to cause the second movable element 31 to drive the clamping portion 15 to be near to the actuating mechanism 30 to cause the clamping element 152 to be projected out of the first slot 143 to exert a force on a wall of a central circular hole 41 of the disc 40 to allow the central circular hole 41 of the disc 40 to be retained to the neck portion 141 of the pick-and-place head 14.

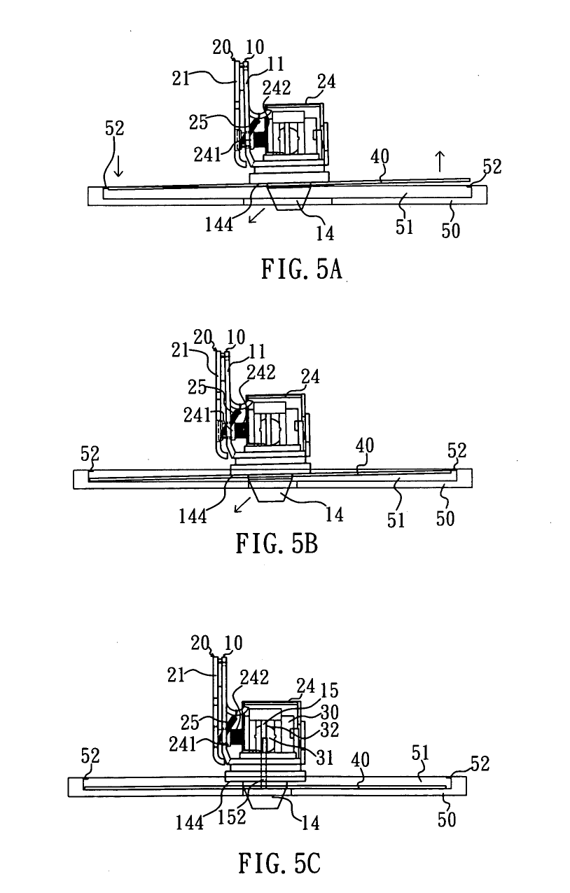

Please refer to FIGS. 5A to 5C. When the disc 40 picked up by the pick-and-place head 14 wants to be place in an accepting groove 51 of a disc tray 50, an action similar to directly using a human's hand to place a disc in a tray is executed, i.e. the first actuating mechanism 24 is first allowed to start to drive the first movable element 241 to move to leave the first vertical plate 21 of the second frame 20, and further to drive a lower end of the first frame 10 to move to leave the first vertical plate 21 of the second frame 20 to cause a pick-and-place face 144 of the disc 40 coupled to the pick-and-place head 14 to be inclined. Because the disc 40 is inclined with an angle, a level width of the disc 40 is shortened relatively to the accepting groove 51 so that a large gap exists between the disc 40 and the accepting groove 51 to enable the disc 40 not to be blocked by tabs 52 on a rim of the accepting groove 51 of the disc tray 50 and placed in the accepting groove 51 easily as FIGS. 5A and 5B show. And then, the second actuating mechanism 30 is closed, the second movable element 31 is exerted with a force through the third elastic element 32 to cause the second movable element 31 to drive the clamping portion 15 to cause the clamping element 152 not to exert a force on the wall of the central circular hole 41 of the disc 40 to allow the disc 40 to drop freely to the accepting groove 51 of the tray 50, and the placing action of the disc 40 can then be completed as FIG. 5C shows.

If the pick-and-place head 14 is allowed to pick up the disc 40 placed in the accepting groove 51 according to the present invention, it only needs to carry out each similar step mentioned above reversely; the disc 40 can then be taken out from the accepting groove 51 smoothly.

The inclinable pick-and-place head of the pick-and-place device according to the present invention is mainly capable of executing an similar action of directly picking up and placing in a disc by a human's hand: allowing a first frame to be movably coupled to a second frame; coupling the first frame to a disc pick-and-place head; allowing the second frame to drive the first frame to move vertically and levelly; driving a bottom of the first frame through an actuating mechanism, for example, solenoid valve, to be near to and leave the second frame to cause a pick-and-place of a disc coupled to the pick-and-place head to be inclined to shorten a level width of the disc relative to an accepting groove. Thereby, the disc is not blocked by tabs of a rim of the accepting groove of the disc tray or a panel of a copier and can be placed in the accepting groove or taken out from the accepting groove conveniently.

The inclinable pick-and-place head of the disc pick-and-place device according to the present invention can place a disc in a disc tray of a copier or take it out of the disc tray smoothly and is capable of more dependably placing a disc into a disc tray or taking it out of the disc tray so as to prevent the disc coping speed from being decreased because the incapability of taking out or placing in the disc will not happen. Moreover, the pick-and-place head disposed with the clamping element may also be replaced with a vacuum sucking disc mechanism.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An inclinable pick-and-place head of a disc pick-and-place device, used for allowing the pick-and-place head of the disc pick-and-place device to have the inclinable function and comprising:
a first frame, provided with at least one first supporting component;
a pick-and-place head, coupled to said first frame and used for picking up and placing in said disc;
a second frame, provided with at least one second supporting component; said first supporting component movably coupled to said second supporting component; and
a first actuating mechanism, used for actuating said first frame to cause a clamping face of said pick-and-place head coupled to said disc to be inclined.

2. The inclinable pick-and-place head of a disc pick-and-place device according to claim 1, wherein said first and said second supporting components are respectively disposed on upper ends of said first and said second frames.

3. The inclinable pick-and-place head of a disc pick-and-place device according to claim 2, wherein at least one first and one second guiding components are respectively disposed on lower ends of said first and said second frames.

4. The inclinable pick-and-place head of a disc pick-and-place device according to claim 3, wherein said first and said second supporting components as well as said first and said second guiding components respectively are a long slot and a pin corresponding to each other.

5. The inclinable pick-and-place head of a disc pick-and-place device according to claim 4, wherein a portion of said pin passed through said long slot is put around with a C-ring.

6. The inclinable pick-and-place head of a disc pick-and-place device according to claim 5, wherein said first actuating mechanism is a first solenoid valve; said first solenoid valve is coupled to said second frame; one end of said first solenoid valve is disposed with a first movable element and a first elastic element; said first elastic element always exerts a force moving said first movable element to be near to said second frame; a lower end of said first frame is coupled to said first movable element; when said first solenoid valve is started, said first solenoid drives said first movable element to separate from said second frame, and further to drive said lower end of said first frame to leave said second frame to cause a pick-and-place face of said pick-and-place head for picking up or placing in a disc is inclined.

7. The inclinable pick-and-place head of a disc pick-and-place device according to claim 6, wherein said second frame comprises a first vertical plate, a second vertical plate and a level plate; said first vertical plate of said second frame is provided with said pins; said first solenoid valve is coupled to said second vertical plate of said second frame; said first solenoid valve is placed between said first and said second vertical plates of said second frame and above said level plate of said second frame.

8. The inclinable pick-and-place head of a disc pick-and-place device according to claim 7, further comprising a second elastic element; two ends of said second elastic element being respectively coupled to said first and said second frames, and said second elastic element always exerting a force moving said first frame to be near to said second frame.
